(19) United States
(12) Patent Application Publication
(10) Pub. No.: US 2008/0135618 A1
(43) Pub. Date: Jun. 12, 2008

(54) Information Recognizing Device and Sheet

(75) Inventors: Yasufumi Kasuya, Tokyo (JP); Tetsuo Ishida, Tokyo (JP)

Correspondence Address: DARBY & DARBY P.C., P.O. BOX 770, Church Street Station, New York, NY, 10008-0770, US

(73) Assignee: KONAMI DIGITAL ENTERTAINMENT CO., LTD., Tokyo (JP)

(21) Appl. No.: 11/814,031

(22) PCT Filed: Dec. 26, 2005
(86) PCT No.: PCT/JP2005/023726

§ 371 Date: Aug. 9, 2007

(30) Foreign Application Priority Data
Jan. 17, 2005 (JP) 2005-009613

(51) Int. Cl. G06K 7/10

(52) U.S. Cl. 235/454

(57) ABSTRACT

An information recognizing device including a first colored area providing excellent durability and easy mounting. The information recognizing device has a first colored area by IR ink; a second colored area WH having a contrast in a visible light region with the first colored area; a communication device for performing infrared light communication through the first colored area; an information reading device for reading information by utilizing the contrast between the first colored area and the second colored area.

### TECHNICAL FIELD

The present invention relates to an information recognizing device and a sheet.

### BACKGROUND ART

A game machine is well-known, providing a race game by self-propelled members traveling a traveling field by tracing guide lanes provided on the traveling field (for example, please refer to the following patent documents 1 to 4). In such game machine, transmitters are provided under the guide lanes, the transmitters transmitting the number of the guide lane. The self-propelled member has a line sensor for detecting the guide lane and a detecting device for detecting the number of the guide lane transmitted from the transmitter. Thereby, the self-propelled member can trace the guide lane while recognizing the number of the guide lane. As the line sensor mounted in the self-propelled member, a type of a sensor for detecting reflecting lights is usually employed. When the guide lane is a first colored area, the area adjoining the guide lane is provided as a second colored area having contrast with the first colored area, and by the contrast, the guide lane is detected. As the stronger contrast provides the easier detection, the guide lane as the first colored area is colored black, and the adjoining area as the second colored area is colored white.

### Patent Document 1: Japanese unexamined patent application 2003-33564

### Patent Document 2: Japanese unexamined patent application 2003-38841

### Patent Document 3: Japanese unexamined patent application 2003-33567

### Patent Document 4: Japanese unexamined patent application 2000-288238

### DISCLOSURE OF THE INVENTION

### Problems to be solved by the Invention

As mentioned above, in the case of an information recognizing device where infrared light is transmitted through the first colored area and information utilizing the first colored area is recognized, the first colored area which is colored black does not transmit the infrared light. Accordingly, windows for transmitting the infrared light are formed in the first colored area. However, in this case, depending on a purpose of use, the windows could cause some problems, like a lack of durability, and a difficulty of mounting. For example, when the first colored area is realized as the guide lane, the height of surface of the traveling field is not even because a difference in height is generated by an area where the window is formed and an area where the window is not formed. The situation will be detrimental to the self-propelled member's traveling, and the guide lane is likely to be damaged by the self-propelled member traveling. Moreover, it is impossible to use for the area where the window is formed, a double-faced tape to make the guide lane adhere to the traveling field. That causes a lack of stability of the guide lane on the traveling field. Theses problems become more significant, if a lot of windows are formed in the first colored area. Furthermore, the first colored area must be mounted so that the portion of the window formed in the first colored area correctly meets the portion of the window formed in the traveling field. That needs troublesome chores.

Therefore, the aim of the present invention is to provide an information recognizing device comprising the first colored area providing excellent durability and easy mounting, and a sheet for mounting the guide lane as the first colored area to the device.

### Means for Solving the Problems

An information recognizing device of the present invention solves the above problems by comprising a first colored area where IR ink is employed; a second colored area having a contrast in a visible light region with the first colored area; a communication device for performing infrared light communication through the first colored area; a information reading device for reading information by utilizing the contrast between the first colored area and the second colored area.

By the information recognizing device of the present invention, as IR ink is employed for the first colored area, infrared light can penetrate the first colored area. Moreover, as the first colored area having contrast with the second colored area, by means of a device capable of detecting the contrast, the information recognizing device can function as a device providing information using the contrast in a visible light region. Accordingly, the information recognizing device of the present information can obtain both information using infrared light communication and information using the contrast without making windows for infrared light to pass the first colored area. Therefore, each of the information obtained by the infrared light communication or the information obtained by the contrast can be used independently. As it is not necessary to provide the windows to the first colored area, it is possible to provide the information recognizing device comprising the first colored area providing excellent durability and easy mounting. In the infrared light communication through the first colored area, it does not matter which side of the first colored area each of the transmitter and the receiver is located

The information reading device may recognize whether the first colored area is or not by utilizing reflected light of visible light. Thereby, it can be recognized whether there is or not the first colored area by utilizing one single wavelength visible light, for example, by a difference between reflecting lights of the visible lights.

Each of the first colored area and the second colored area may be composed of a plurality of lines, each line composing the first colored area and each line composing the second colored area may be arranged to adjoin with each other. By utilizing the infrared light communication, line information may be transmitted, the line information being for identifying a line penetrated by infrared light used by the infrared light communication within the plurality of lines composing the first colored area. The information reading device may reads information for detecting each of the plurality of lines composing the first colored area. Thereby, the infrared light communication can be used for identification information for provided lines, and the reading device can be used for information related to detecting each of the lines.

The information recognizing device may further comprise; a traveling field where the first colored area and the second colored area are provided; a self-propelled member traveling on the traveling field by tracing the plurality of lines composing the first colored area; and an IR transmitter for transmitting the line information by utilizing infrared light, wherein the IR transmitter is provided under the traveling field, and the self-propelled member has an IR detecting device and the information reading device, the IR detecting device detecting the line information transmitted from the IR transmitter when passing over the IR transmitter. Thereby, the self-propelled member can detect a line to be traced by the information reading device, while obtaining the line information of the line by the IR transmitter. Accordingly, for example, in a case where the line information is a line number and the location information of the self-propelled member is specified by the line number, the location information of the self-propelled member can be corrected by the IR transmitter.

Further, the IR ink may be colored almost black in a visible light region, and the second colored area may be colored almost white. Thereby, as the first colored area is colored almost black by IR ink, the contrast between the first colored area and the second colored is strong. Therefore, it is easy for the information reading device to read information by the contrast. Moreover, it is hard to recognize the infrared light communication device through the first colored area.

An information recognizing method including the steps; providing a first colored area where IR ink is employed and a second colored area having a contrast in a visible light region with the first colored area; reading information by utilizing the contrast between the first colored area and the second colored area, while performing infrared light communication through the first colored area. This information recognizing method can be realized as an information recognizing device of the present invention.

A sheet of the present invention solves the above problems by a sheet for forming on a traveling filed, a travel track comprising a plurality of guide lanes arranging in a stripe state for all circumference of the travel track, wherein each of the plurality of guide lanes composing the travel track is colored by IR ink, each area adjoining each of the guide lanes is colored to have contrast in a visible light region with the guide lane. When the sheet of the present invention is used, the travel track can be formed only by linking and mounting the plurality of sheets on the traveling field. The guide lanes provided on the sheets can be used as the guide lanes of the information recognizing device of the present invention.

### EFFECTS OF THE INVENTION

As mentioned above, according to the present invention, an information recognizing device and the like comprising the first colored area providing excellent durability and easy mounting can be provided, by a communication device for performing infrared light communication through the first colored area where IR ink is employed and a information reading device for reading information by utilizing the contrast between the first colored area and the second colored area.

### BRIEF DESCRIPTION OF DRAWING

FIG. 1 is a diagram showing one embodiment of an information recognizing device of the present invention;

FIG. 2 is a diagram showing a self-propelled member and a field which compose a game machine shown in FIG. 1;

FIG. 3 is a construction diagram of a self-propelled member shown in FIG. 2;

FIG. 4 is a diagram showing tracks provided on a lower traveling filed shown in FIG. 2.

FIG. 5 is a diagram showing a track sheet for forming the tracks shown in FIG. 4;

FIG. 6 is an enlarged section view of the track sheet shown in FIG. 5.

FIG. 7 is a diagram showing a progress line provided on the lower traveling field shown in FIG. 2;

FIG. 8 is a diagram showing a location notifying device provided on the lower traveling field shown in FIG. 2;

FIG. 9 is a diagram showing a state where the self-propelled member comes close to the location notifying device shown in FIG. 8;

FIG. 10 is a diagram showing a state where the self-propelled member shown in FIG. 9 passes over the location notifying device; and

FIG. 11 is a diagram showing a state where the information recognizing device according to the present invention is realized as a wheel location control device.

### BEST MODE FOR CARRYING OUT THE INVENTION

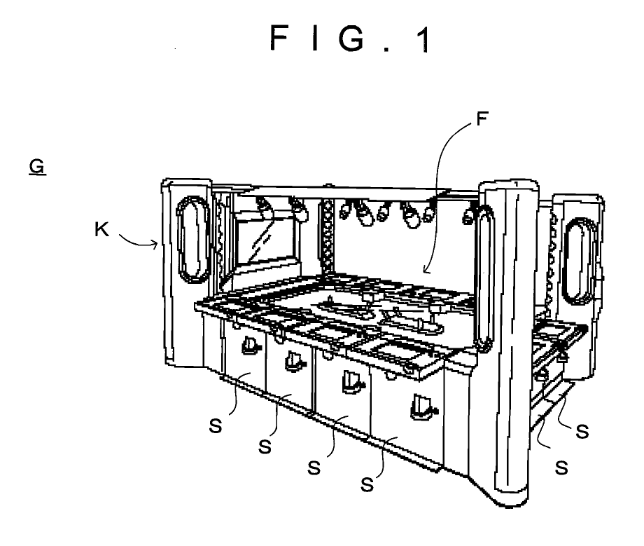

FIG. 1 is a diagram showing one embodiment of an information recognizing device of the present invention. In this embodiment, the information recognizing device is realized as a game machine G where to play a game. A housing K as a game machine body of the game machine G has a field F, and a plurality of stations S . . . S for accepting player's operation are arranged around the field F.

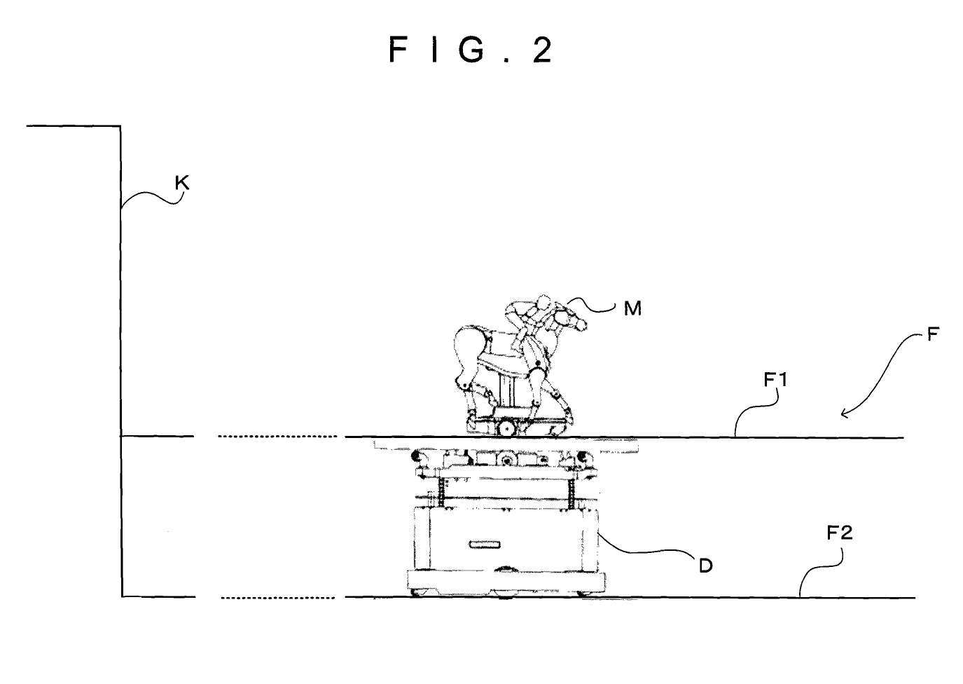

As shown in FIG. 2, the field F has an upper traveling field F1 and a lower traveling field F2. A self-propelled member D is provided on the lower traveling field F2. A model member M is adhered to the self-propelled member D through the upper traveling field by a magnetic force. At the game machine G, a line guiding type of race is carried out, where each of a plurality of self-propelled members D traces to travel a guide lane, mentioned later, provided on the lower traveling field F2 while drafting the model member M corresponding to the self-propelled member D. In this embodiment, the model member M is a horse model, and the line guiding type of race is carried out as a horse racing by six horse models M.

Consequently, in this embodiment, six self-propelled members D, having the same construction, are prepared. The line guiding type of race progresses by data reception and transmission between the self-propelled member D and the housing K. Infrared light is used as a carrier wave for the data reception and transmission. The reception and transmission of data between the self-propelled member D and the housing K, and the control processes by the received and transmitted data can be performed by conventional methods.

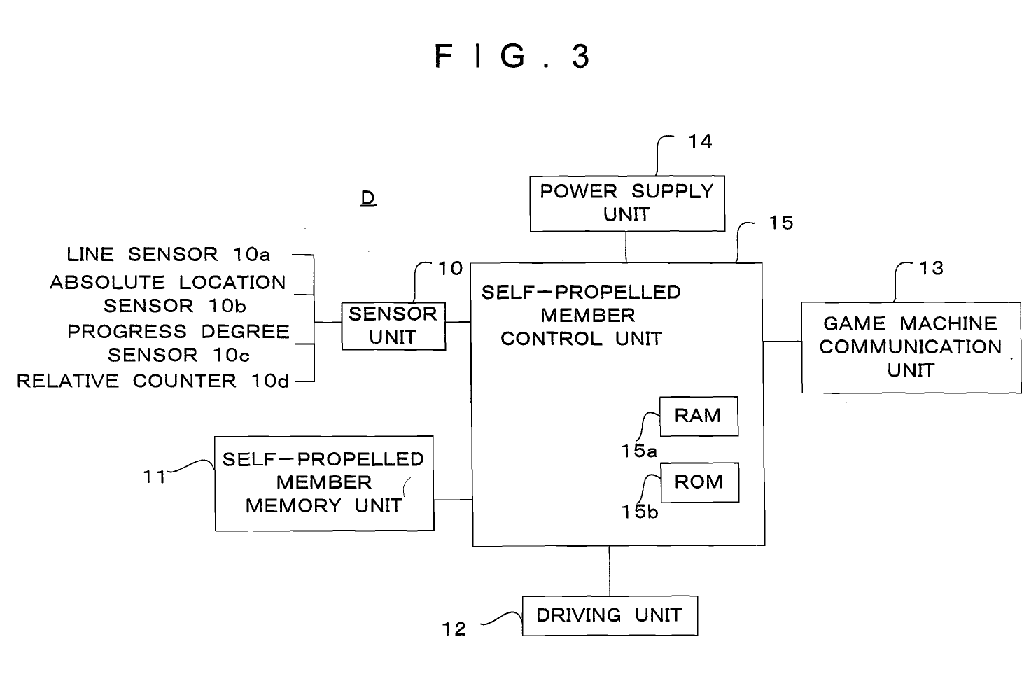

An outline of construction of the self-propelled member D will be explained by using FIG. 3. The self-propelled member D has a sensor unit 10, a self-propelled member memory unit 11, a driving unit 12, a game machine communication unit 13 for transmitting and receiving data with the housing K, a power supply unit 14 for supplying power to the self-propelled member D, and a self-propelled member control unit 15 for controlling the constructions 10 . . . 14 of the self-propelled member. The self-propelled member memory unit 11 is composed of an in volatile storage medium, and various kinds of information related to the self-propelled member D is stored therein. The driving unit 12 has a motor unit comprising a left motor and a right motor, both being connected with a gear system and a tire.

The self-propelled member control unit 15 has a CPU and various kinds of peripheral circuits necessary for CPU's actions, such as a RAM 15a and a ROM 15b, and is constructed as a computer. Each sensor of the sensor unit 10 can be conventional one. For example, as a sensor for recognizing location information, a line sensor 10a, an absolute location sensor 10b, a progress degree sensor 10c and a relative counter 10d are provided at the bottom area of the self-propelled member D. The location information of the self-propelled member D and how to obtain the location information by the sensor 10a-10d will be explained later.

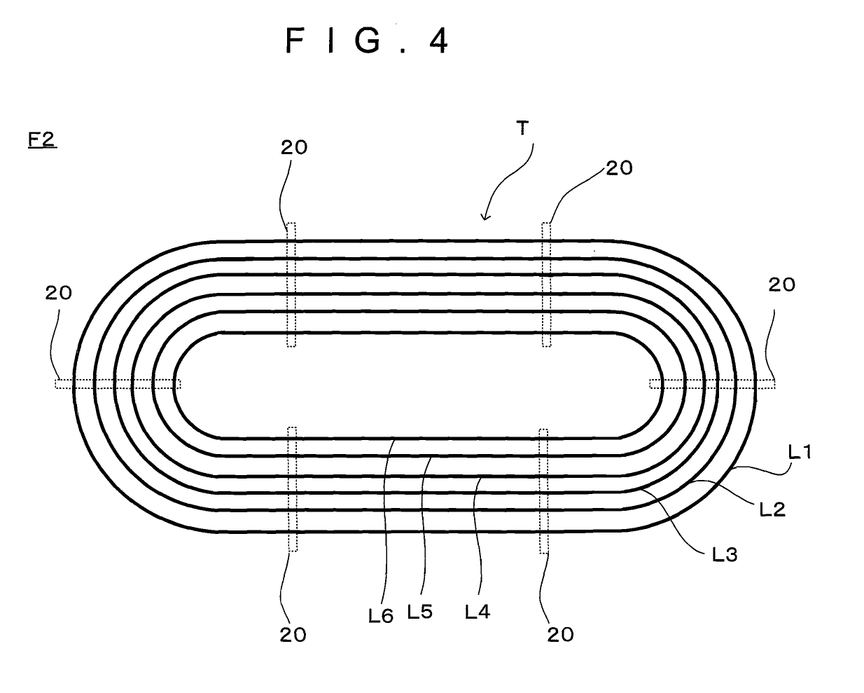

Next, it will be explained of the lower traveling field F2 where the self-propelled member D travels. The lower traveling field F2 has a track T comprising plural circular guide lanes L . . . L6 as shown in FIG. 4. Each of the guide lanes L1 . . . L6 corresponds to each of guide lane numbers L1 . . . L6. Hereinafter, when it is not needed to distinguish each of the guide lanes L1 . . . L6, it is referred to as “the guide lane L”. Additionally, the track T has 6 pieces of location notifying devices 20 . . . 20. The location notifying devices 20 . . . 20 will be explained later.

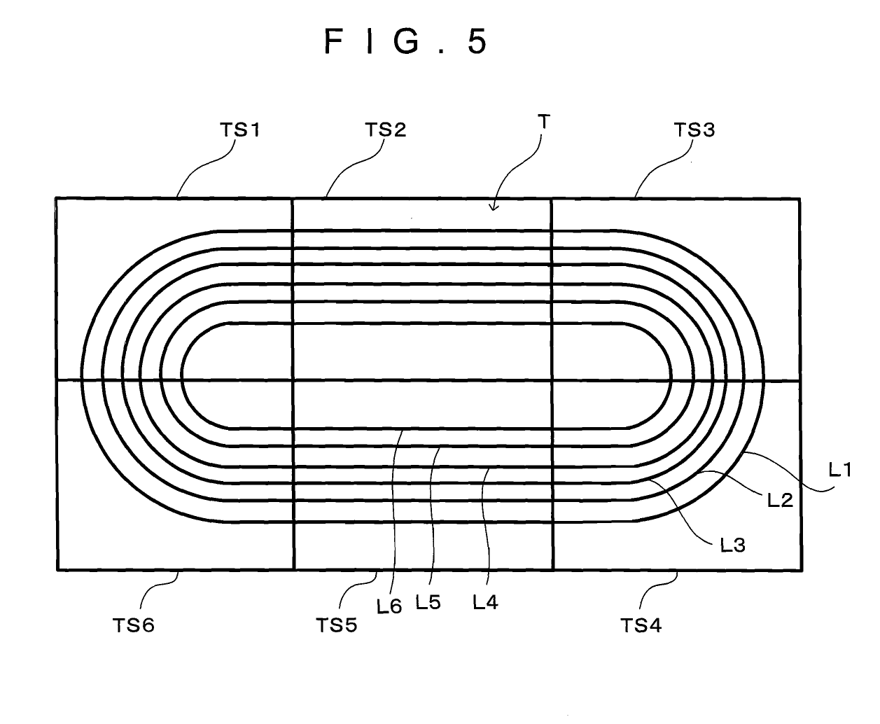

The track T is formed by linking and mounting track sheets TS1 . . . TS6 on the lower traveling field F2, each of the track sheets has the guide lanes L1 . . . L6 to form the track Tin advance as shown in FIG. 5.

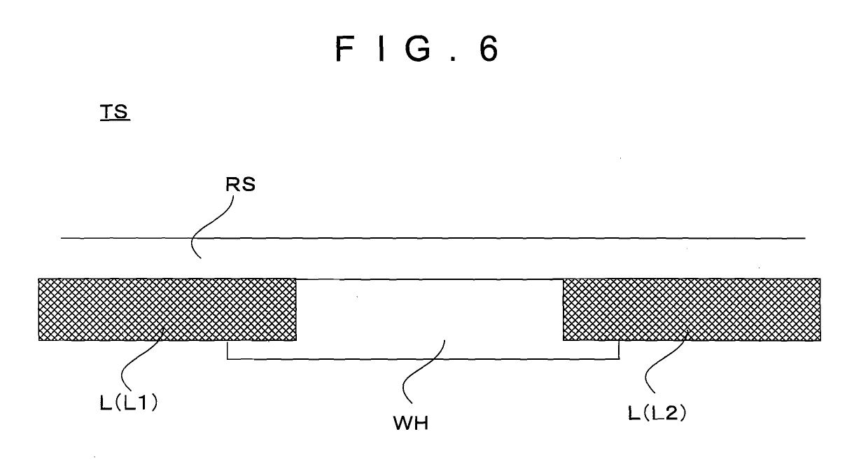

FIG. 6 is an enlarged section view of the guide lane L formed in the track sheet TS. In the track sheet TS, on the under side of transparent lexan sheet (trade mark) RS to be the upper surface when the track sheet TS is mounted on the lower traveling field F2, each of the guide lanes L employing almost black of IR ink are provided separately with a space, and to the space, a white ink area WH is provided. When looking down the lexan sheet RS, the black guide lanes L and the white ink area WH between the guide lanes L to have contrast with the guide lane L are formed. Thereby, the guide lane L functions as the first colored area, and the white ink area WH functions as the second colored area. It is not needed to mount windows to the guide lane L employing black ink. FIG. 6 shows a portion where the guide lane L1 and the guide lane L2 are formed.

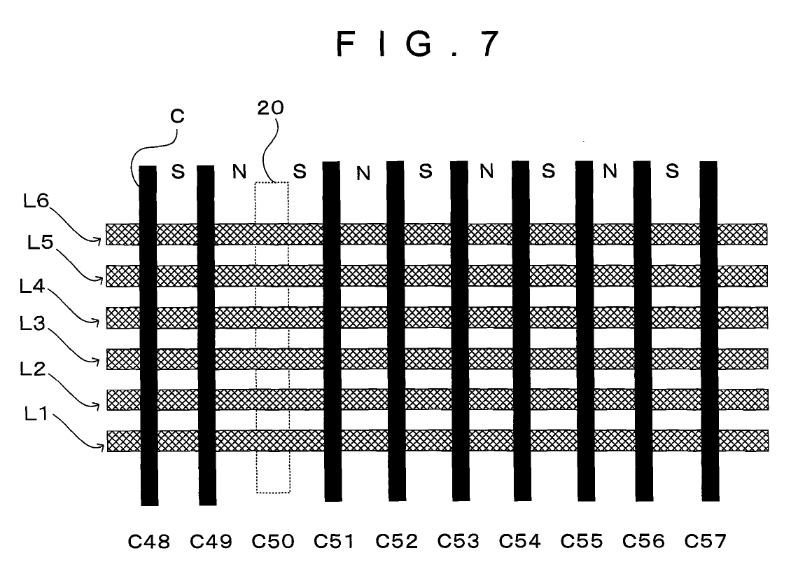

Moreover, the lower traveling field F2 has a plurality of progress lines C . . . C arranged to all round of the track, the progress lines C . . . C crossing at right angle to the guide lanes L. Each of the progress lines C . . . C is a magnetic line and each space between the progress lines is a constant length. Each of the progress lines C . . . C corresponds to a progress degree, the progress degree incrementing by one from “0, which is set to a determined progress line C. In FIG. 7, from the progress degree C28 of the progress line C to the progress degree C57 of the progress line C are shown, and the sate where the location notifying device 20 is provided at the location of the progress degree C50.

In this embodiment, the location information of the track T is determined by the guide lane number and the progress degree above mentioned. Hereinafter, for example, the location information determined by the guide lane number L3 and the progress degree C32 is represented as (L3, C52). The self-propelled member D holds own location information, and travels while constantly updating the own location information. The location information can be stored, for example, in RAM 15a. The location information held by the self-propelled member D is adjusted to be correct each time when the self-propelled member D passes over the location notifying device 20. Hereinafter, a case where the self-propelled member D traveling on the guide lane L3 passes over the location notifying device 20 located at the progress degree C50 will be explained as an example to explain how to obtain the location information of the self-propelled information D.

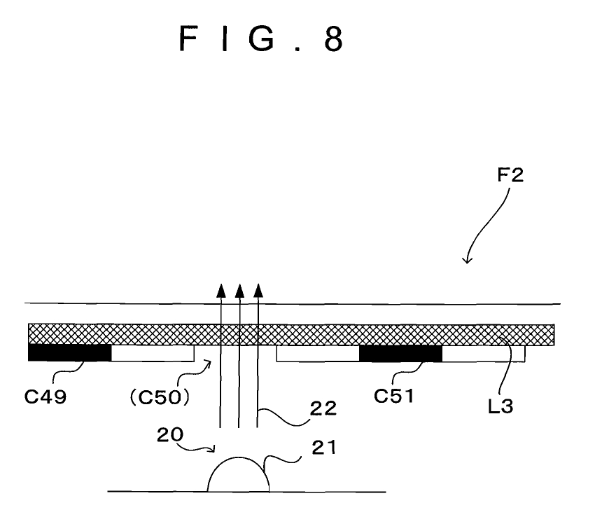

First, the location notifying device 20 will be explained in reference to FIG. 8. The location notifying device 20 comprises six pieces of infrared light transmitters 21 located under the traveling field. Each of the infrared light transmitters 21 is provided to be located under each of the guide lanes L . . . L6, and the guide lane number corresponding to each guide lane L and the progress degree are transmitted as adjusting location information by the infrared light. Thereby, the infrared light transmitter 21 functions as a communication device and an IR transmission device. Accordingly, one location notifying device 20 has six infrared transmitters 21 so that each of which corresponds to each guide lane L. FIG. 8 shows the infrared light transmitter 21 located under the guide lane L3 in the location notifying device 20 provided to the location of the progress line C50. Namely, the adjusting location information (L3, C50) is transmitted from the infrared light transmitter 21 shown in FIG. 8.

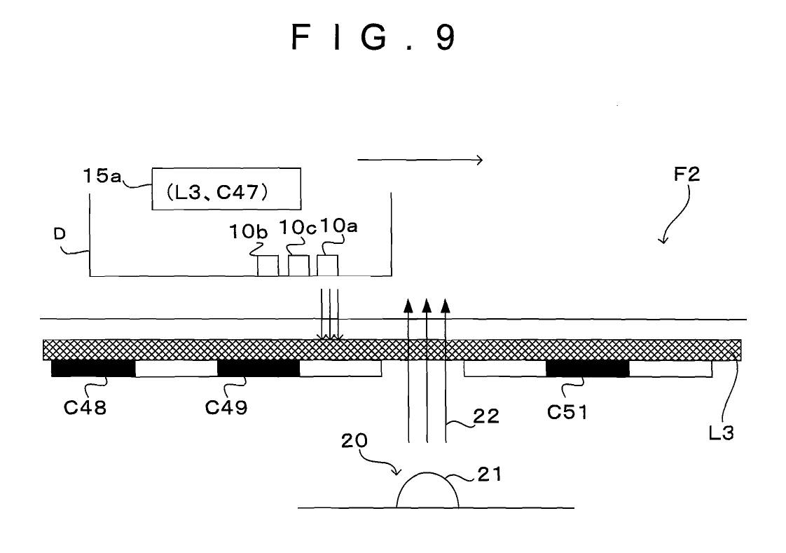

FIG. 9 shows a state where the self-propelled member D traveling while tracing the guide lane L3, passes over the progress degree C49 and heading the location of the progress degree C50 The self-propelled member D can trace the guide lane L3 by a line sensor 10a mounted in the bottom thereof. The line sensor 10a has a light receiving element for detecting reflected light of visible light. The line sensor 10a detects the guide lane L3 by the difference in the reflected lights caused by the contrast between the black guide lane L3 and the white adjoining area. Thereby, the line sensor 10a functions as an information reading device.

When it is judged by the line sensor 10a that the self-propelled member D has deviated from the guide lane L3, the self-propelled member D is controlled to trace the guide lane L3 by the self-propelled member control unit 15. A known conventional method can be employed as this control method. Additionally, when the self-propelled member D changes the guide lanes L, the relative counter 10d can grabs the guide lane number, and the guide lane number of the location information held by the self-propelled member D is updated to the guide lane number of the changed guide lane L.

Moreover, the self-propelled member D recognizes the pass-over of the progress line C which is a magnetic line by a progress sensor 10c which is a magnetic sensor, and counts and update the progress degree of the own location information each time one progress line C is passed over. As mentioned above, the self-propelled D can obtain the own location information.

However, in the case where the update of the location information is controlled only within the self-propel led member D, some deviance could sometimes occur. The self-propelled member D just having passed over the progress line C49 is shown in FIG. 9. The location information (L3, C47) of the self-propelled member D is swerving, though the correct location information is (L3. C49).

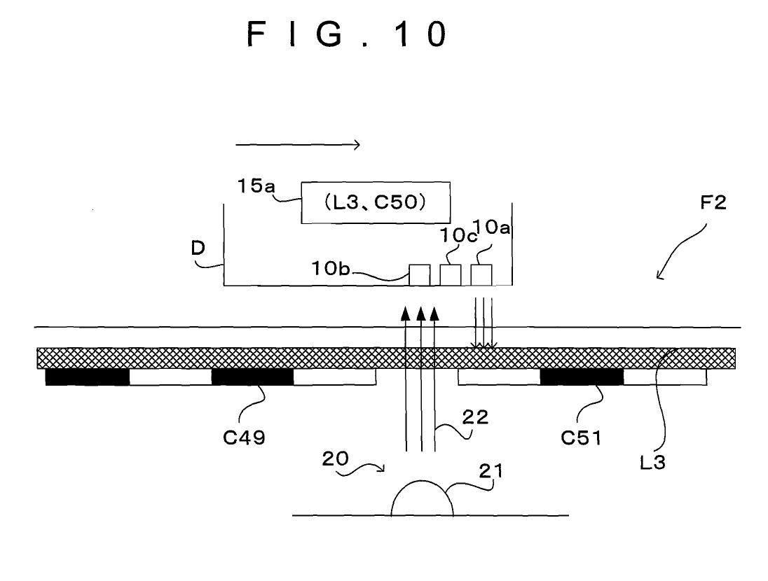

FIG. 10 shows the self-propelled member D just having passed over the location notifying device 20. The guide lane L3 is detected by means of the line sensor 10a, and the adjusting location information 22 is detected by means of the absolute location sensor 10b. Thereby, the absolute location sensor 10b functions as a communication device and an IR detecting device. When the absolute location sensor 10b detects the adjusting location information 22, the location information of its own is set by the self-propelled member control unit 15, to the location information (L3, C50) which the detected adjusting location information 22 indicates. Accordingly, even if the location information of the self-propelled member D swerves, the location information gets adjusted by the location notifying device 20. Therefore, the traveling precision of the self-propelled member D can get higher.

The present invention is not limited to the above embodiment, but can be executed as various embodiments. For example, in the above mentioned embodiment, the infrared light transmitter is mounted to the location notifying device 20 provided under the lower traveling field F2, and a device for detecting the infrared light is mounted to the self-propelled member D, but the infrared light can be transmitted from the self-propelled member and the transmitted infrared light can be detected at the lower traveling field F2.

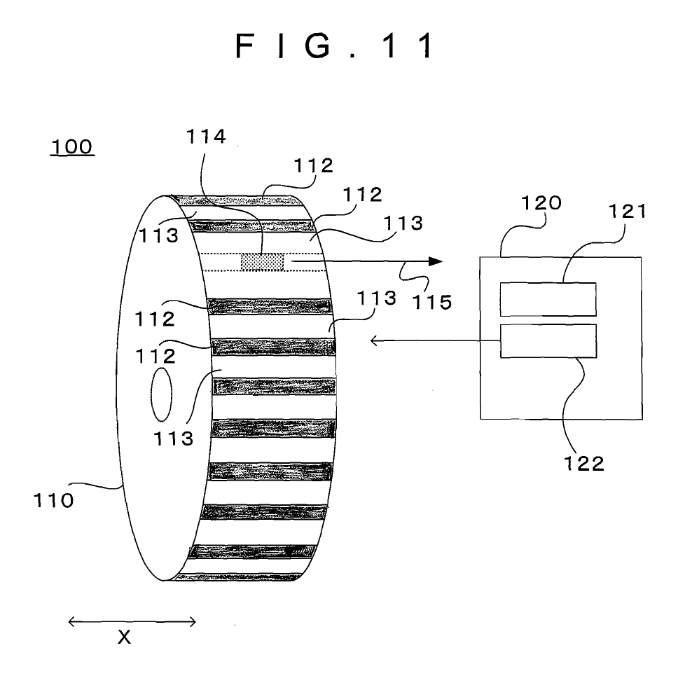

Additionally, the present invention can be executed as a wheel control device 100 as shown in FIG. 11. This wheel control device 100 comprises a wheel 110, a location detecting unit 120 for detecting the location of the wheel 110. The location detecting unit 120 comprises an absolute location sensor 121 and a line sensor 122. The absolute location sensor 121 and the line sensor 122 could be the same as the above mentioned ones. About the wheel 110, stripe patterns parallel to the axis direction X are applied to all circumference of the side surface of the wheel 110. The stripe patterns comprise a plurality of black lines 112 employing IR ink and a plurality of lines 113 each having contrast with each of the black lines 112. Both of the absolute location sensor 121 and the line sensor 122 are set to face the side surface of the wheel.

Each of the lines 112 corresponds to a line number starting a predetermined line 112 set as “0” and incrementing with every line 112. The wheel 110 has further a location notifying device 114, for example, at four of locations for the lines 112 to be located. The location notifying device 114 transmits by utilizing infrared light as adjusting location information, the line number of the line 112 where the location notifying device 114 is located.

The location detecting unit 120 holds the line number of the line 112 passing the front of the location detecting unit 120, and updates the holding line number by detecting to count the lines 112 passing by rotation of the wheel 110 by means of the line sensor 122. Then, when the wheel 110 stops, the line number of the line 112 counted last is held as the location of the wheel 110.

When the location detecting device 114 passes the location detecting unit 120 by the rotation of the wheel 110, the absolute location sensor 121 detects the adjusting location information 115 transmitted from the location notifying device 114. Then the line number held by the location detecting unit 120 is set to be the line number of the detected adjusting location information 115. Accordingly, the line number held by the location detecting unit 120 can be corrected by the location notifying device 114. Thereby, the location recognizing precision of the wheel to be rotated gets higher.

Additionally, for the above mentioned wheel location control device, the wheel 110 could be a roulette and the location detecting unit 120 could be a device for detecting stop location of the roulette.

1. An information recognizing device comprising:
a first colored area where IR ink is employed;
a second colored area having a contrast in a visible light region with the first colored area;
a communication device for performing infrared light communication through the first colored area;
a information reading device for reading information by utilizing the contrast between the first colored area and the second colored area.

2. The information recognizing device according to claim 1, wherein
the information reading device recognizes whether the first colored area is or not by utilizing reflected light of visible light.

3. The information recognizing device according to claim 1, wherein
each of the first colored area and the second colored area comprises a plurality of lines,
each line composing the first colored area and each line composing the second colored area are arranged to adjoin with each other,
by utilizing the infrared light communication, line information is transmitted, the line information being for identifying a line penetrated by infrared light used by the infrared light communication within the plurality of lines composing the first colored area,
the information reading device reads information for detecting each of the plurality of lines composing the first colored area.

4. The information recognizing device according to claim 3, further comprising;
a traveling field where the first colored area and the second colored area are provided;
a self-propelled member traveling on the traveling field by tracing the plurality of lines composing the first colored area; and
an IR transmitter for transmitting the line information by utilizing infrared light, wherein
the IR transmitter is provided under the traveling field,
the self-propelled member has an IR detecting device and the information reading device, the IR detecting device detecting the line information transmitted from the IR transmitter when passing over the IR transmitter.

5. The information recognizing device according to claim 1, wherein
the IR ink is colored almost black in a visible light region, and the second colored area is colored almost white.

6. An information recognizing method including the steps;
providing a first colored area where IR ink is employed and a second colored area having a contrast in a visible light region with the first colored area;
reading information by utilizing the contrast between the first colored area and the second colored area, while performing infrared light communication through the first colored area.

7. A sheet for forming on a traveling filed, a travel track comprising a plurality of guide lanes arranging in a stripe state for all circumference of the travel track, wherein
each of the plurality of guide lanes composing the travel track is colored by IR ink, each area adjoining each of the guide lanes is colored to have contrast in a visible light region with the guide lane.

8. The information recognizing device according to claim 2, wherein
each of the first colored area and the second colored area comprises a plurality of lines, each line composing the first colored area and each line composing the second colored area are arranged to adjoin with each other,
by utilizing the infrared light communication, line information is transmitted, the line information being for identifying a line penetrated by infrared light used by the infrared light communication within the plurality of lines composing the first colored area,
the information reading device reads information for detecting each of the plurality of lines composing the first colored area.

9. The information recognizing device according to claim 8, further comprising;
a traveling field where the first colored area and the second colored area are provided;
a self-propelled member traveling on the traveling field by tracing the plurality of lines composing the first colored area; and
an IR transmitter for transmitting the line information by utilizing infrared light, wherein
the IR transmitter is provided under the traveling field,
the self-propelled member has an IR detecting device and the information reading device, the IR detecting device detecting the line information transmitted from the IR transmitter when passing over the IR transmitter.

10. The information recognizing device according to claim 2, wherein
the IR ink is colored almost black in a visible light region, and the second colored area is colored almost white.

11. The information recognizing device according to claim 3, wherein
the IR ink is colored almost black in a visible light region, and the second colored area is colored almost white.

12. The information recognizing device according to claim 4, wherein
the IR ink is colored almost black in a visible light region, and the second colored area is colored almost white.

13. The information recognizing device according to claim 8, wherein
the IR ink is colored almost black in a visible light region, and the second colored area is colored almost white.

14. The information recognizing device according to claim 9, wherein
the IR ink is colored almost black in a visible light region, and the second colored area is colored almost white.
